(19) United States
(12) Patent Application Publication
(10) Pub. No.: US 2010/0084446 A1
(43) Pub. Date: Apr. 8, 2010

(54) MOTORCYCLE HELMET SECUREMENT SYSTEM AND METHODS OF AFFIXMENT AND USAGE THEREOF

(76) Inventors: Damon E. Skillern, Rocklin, CA (US); Robert Rogers, Folsom, CA (US)

Correspondence Address: MESCHKOW & GRESHAM, P.L.C., 7250 NORTH SIXTEENTH STREET, SUITE 318, PHOENIX, AZ, 85020-5279, US

(21) Appl. No.: 12/247,893

(22) Filed: Oct. 8, 2008

(51) Int. Cl. B60R 7/00

(52) U.S. Cl. 224/275

(57) ABSTRACT

A motorcycle helmet securement system (20) and methods for affixment (100) and use (200) of the helmet securement system (20) are provided. The helmet securement system (20) includes a motorcycle seat (30), first and second securement devices (40,60), and a motorcycle helmet (24). Each of the two securement devices (40,60) is made up of a first securement end (43,63) with a first component (51,71) of a buckle (50,70) attached thereto, a second securement end (47,67) with a second component (52,72) of the buckle (50,70) attached thereto, and first and second affixment ends (44,48,64,68) affixed to the motorcycle seat (30). The motorcycle helmet (24) has a chin guard (26). The first securement ends (43,47,63,67) of the securement devices (40,60) pass through an inside (28) of the helmet (24), over the chin guard (26), and engage the second securement ends (44,48,64,68) of the securement devices (40,60). In this manner, a motorcycle helmet (24) may be secured to the passenger seat (30) of a motorcycle (22) when not in use.

### TECHNICAL FIELD OF THE INVENTION

The present invention relates to the field of securing motorcycle helmets. More specifically, the present invention relates to securing motorcycle helmets on the external surface of a motorcycle.

### BACKGROUND OF THE INVENTION

The use of a helmet has been shown to provide significant protection for a rider of a motorcycle or similar vehicle (e.g., a scooter, moped, all-terrain vehicle, or other open conveyance). The risks associated with riding a motorcycle are not limited to the operator of the motorcycle. Rather, when there is a passenger, this passenger is exposed to the same risks.

An operator will often be prepared, donning his/her helmet before mounting the motorcycle, thus ensuring that he/she has protection while riding. However, a problem exists when the operator wishes to carry a passenger. It is difficult to provide helmet protection for a passengers at all times. For example, if an operator elects to have as a passenger one who does not possess a helmet, either the passenger will have to ride without protection, or the operator will have to forego his/her own protection to ensure that his/her passenger is protected.

Another problem is that, despite the attendant risks, an operator riding alone may wish to forgo the use of a helmet over a portion of his/her trip. A problem then arises as to what the operator is to do with his/her helmet when he/she chooses not to wear it. It is desirable, therefore, that some means be provided for securing a helmet to a motorcycle when the helmet is not in use.

An unused helmet is conventionally secured to the motorcycle by means of bungee cords. However, depending upon the number and length of the bungee cords involved, the attachment and/or detachment of the spare helmet can be a lengthy and/or involved process. Also, the bungee cords, being elastic, can result in the loss of the spare helmet if not properly secured. This may be not merely an inconvenience, but may result in the loss of the helmet and/or pose a physical danger to the operator and others.

Methods have been found to store an unused helmet within the body of a motorcycle. These methods are limited to cruisers or other large motorcycles, typically those having large saddlebags. For smaller, more aerodynamic motorcycles, such as sports bikes, there is usually insufficient space within the faring or elsewhere to store a spare helmet.

Furthermore, there exists the potential of an unnecessary burden upon the performance, comfort, and/or appearance of the motorcycle when large or cumbersome devices, such as bungee cords or saddlebags, that may be used to secure an unused helmet continue to extend beyond the body of the motorcycle even when no unused helmet is being secured to the motorcycle.

What is needed, therefore, is a means to store a spare motorcycle helmet upon the body of a motorcycle, regardless of the size of the motorcycle. This means should desirably be simple in construction and operation, should securely mount the helmet to prevent loss, should be safe, should be cost-effective, and should impose no significant burden when no helmet is being secured to the motorcycle.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 depicts an oblique view of a motorcycle helmet securement system securing a motorcycle helmet upon a motorcycle seat in accordance with a preferred embodiment of the present invention;

FIG. 2 depicts an oblique view of first and second securement devices for the motorcycle helmet securement system of FIG. 1 in accordance with a preferred embodiment of the present invention;

FIG. 3 depicts an oblique view of first and second securement devices for the motorcycle helmet securement system of FIG. 1 in accordance with an alternative preferred embodiment of the present invention;

FIG. 4 depicts a block diagram of a process to affix the first and second securement devices of FIG. 2 to a motorcycle seat in accordance with a preferred embodiment of the present invention;

FIG. 5 depicts an exploded oblique view of the affixment of the first and second securement devices of FIG. 2 to a motorcycle seat in accordance with a preferred embodiment of the present invention;

FIG. 6 depicts a block diagram of a process to use the motorcycle helmet securement system of FIG. 1 in accordance with a preferred embodiment of the present invention;

FIG. 7 depicts an exploded oblique view of the placement/removal of a motorcycle helmet upon/from a motorcycle seat in accordance with a preferred embodiment of the present invention;

FIG. 8 depicts an oblique view of the engagement/disengagement of securement ends of the securement devices of FIG. 2 in accordance with a preferred embodiment of the present invention; and

FIG. 9 depicts an oblique view of the securement of a motorcycle helmet upon a motorcycle seat through the process of FIG. 6 in accordance with a preferred embodiment of the present invention.

### DETAILED DESCRIPTION OF THE PREFERRED EMBODIMENTS

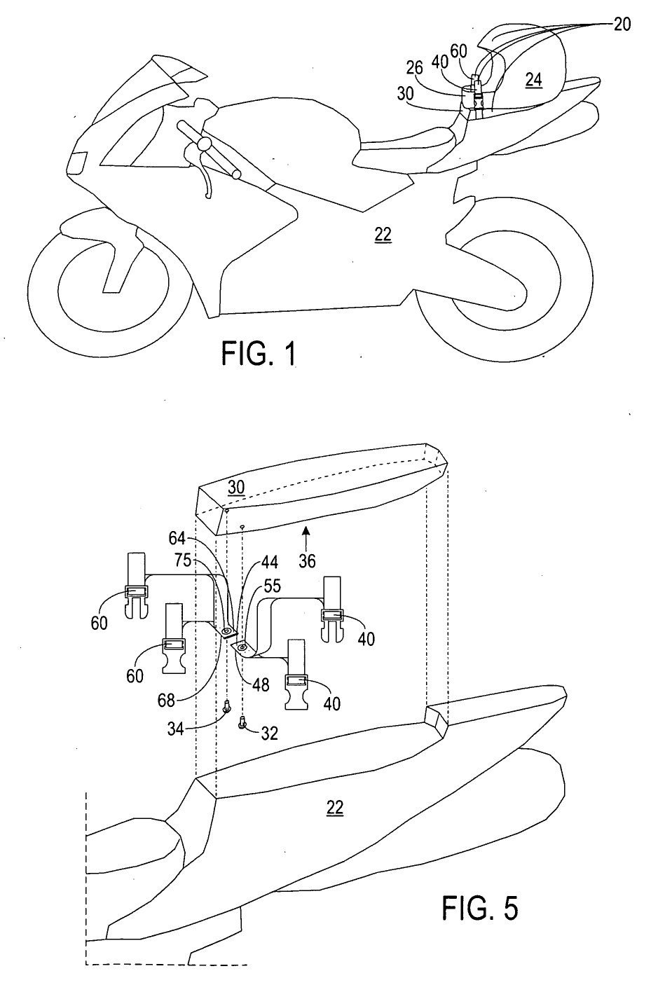

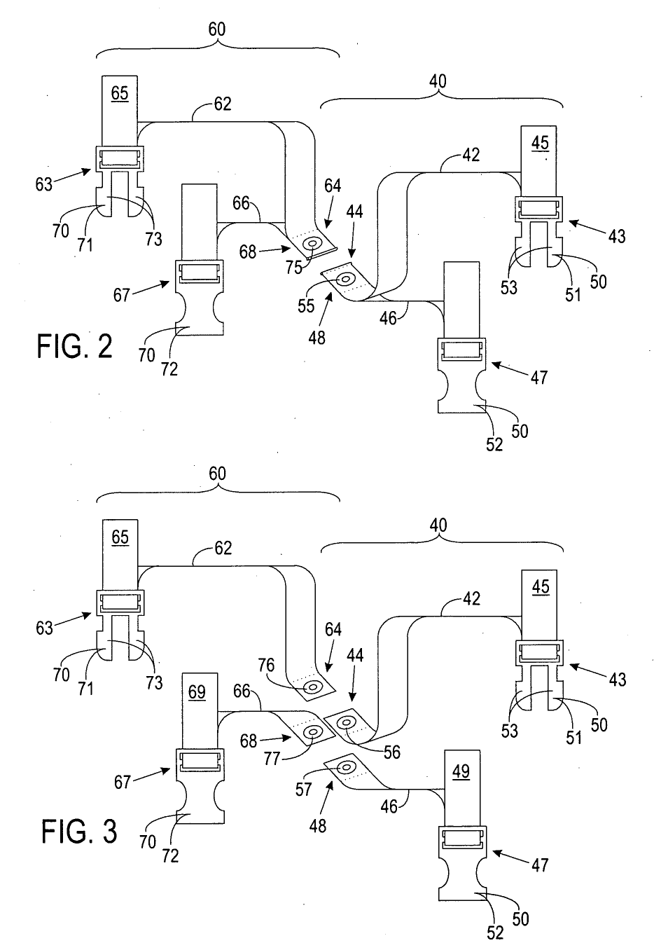

FIG. 1 depicts an oblique view of a motorcycle helmet securement system 20 securing a motorcycle helmet 24 upon a motorcycle seat 30 of a motorcycle 22, and FIG. 2 depicts an oblique view of a first securement device 40 and a second securement device 60 for securement system 20 in accordance with a preferred embodiment of the present invention. The following discussion refers to FIGS. 1 and 2.

Those skilled in the art will appreciate that the term “motorcycle,” as used in this discussion, refers to a motorcycle, motor scooter, moped, three- or four-wheel all-terrain vehicle, or similar open vehicle.

Motorcycle helmet securement system 20 is a simple, secure, safe, and cost-effective system for securing a spare motorcycle helmet 24 upon the second seat of a motorcycle. Securement system 20 includes motorcycle seat 30, first securement device 40, second securement device 60, and motorcycle helmet 24.

Motorcycle seat 30 is preferably the conventional second seat of motorcycle 22, i.e., the passenger seat. Seat 30 is removable from motorcycle 22 in a manner normal for any particular motorcycle 22 and well known to those skilled in the art. Motorcycle seat 30 is desirably modified as discussed hereinafter to be a part of securement system 20.

Motorcycle helmet 24 is of the type having a chin guard 26. Chin guard 26 configures helmet 24 so that securement devices 40 and 46 may appropriately secure helmet 24 to motorcycle seat 30, as discussed hereinafter.

Desirably, first and second securement devices 40 and 60 are substantially identical. First securement device 40 is made up of a first strap 42 with a first securement end 43 and a first affixment end 44, and a second strap 46 with a second securement end 47 and a second affixment end 48.

Similarly, second securement device 60 is also made up of a first strap 62 with a first securement end 63 and a first affixment end 64, and a second strap 66 with a second securement end 67 and a second affixment end 68.

Desirably, straps 42, 46, 62, and 66 are fabricated of nylon webbing or some similar material well known to those skilled in the art. However, those skilled in the art will appreciate that the material of which straps 42, 46, 62, and 66 are fabricated is not germane. Any desirable material may be used without departing from the spirit of the present invention.

First securement device 40 includes a first buckle 50. First buckle 50 has a first buckle component 51 attached to first securement end 43 on first strap 42, and a second buckle component 52 attached to second securement end 47 on second strap 46. First and second buckle components 51 and 52 of first buckle 50 are configured to engage each other securely.

Similarly, second securement device 60 includes a second buckle 70. Second buckle 70 has a first buckle component 71 attached to first securement end 63 on first strap 62, and a second buckle component 72 attached to second securement end 67 on second strap 66. First and second buckle components 71 and 72 of second buckle 70 are configured to engage each other securely.

In the preferred embodiment of FIG. 2, buckles 50 and 70 are conventional quick-release buckles of a type commonly found on straps. This type of buckle has a male component and a female component, shown herein for first securement device 40 as first buckle component 51 attached to first securement end 43 and as second buckle component 52 attached to second securement end 44, and for second securement device 60 as first buckle component 71 attached to first securement end 63 and as second buckle component 72 attached to second securement end 64.

Those skilled in the art will appreciate that the exact type of buckle used for buckles 50 and 70, or which buckle components are affixed to which securement ends, is not germane. Other buckle types attached in any desire configuration may be used without departing from the spirit of the present invention.

In FIG. 2, it may be seen that first tag ends 45 and 65 protrude from first (male) buckle components 51 and 71,and second tag ends 49 and 69 protrude from second (female) buckle components 52 and 72 for both first and second securement devices 40 and 60, respectively. First tag ends 45 and 65 are portions of first straps 42 and 62 extending beyond first securement ends 43 and 63. Similarly, second tag ends 49 and 69 are portions of second straps 46 and 66 extending beyond second securement ends 47 and 67. Tag ends 45, 49, 65, and 69 are used to snug helmet 24 to seat 22, as discussed hereinafter.

FIG. 3 depicts an oblique view of first and second securement devices for motorcycle helmet securement system 20 in accordance with an alternative embodiment of the present invention. The following discussion refers to FIGS. 2 and 3.

In the preferred embodiment of FIG. 2, for each of first and second securement devices 40 and 60, first and second straps 42 and 46 or 62 and 66 are conjoined at affixment ends 44 and 48 or 64 and 68. That is, they are formed of a single piece of strapping material, where affixment ends 44 and 48 or 64 and 68 are proximate each other, essentially abutting each other. This embodiment serves two potential functions: it may reduce the manufacturing cost of securement devices 40 and 60; and it may increase the strength of the affixment of securement devices 40 and 60 to motorcycle seat 30 (discussed hereinafter).
NOTE: Paragraphs renumbered in final version from this point on.

Furthermore, the preferred embodiment of FIG. 2 depicts first and second affixment ends 44 and 48 of first securement device 40 coupled together by means of a first grommet 55, and first and second affixment ends 64 and 68 of second securement device 60 coupled together by means of a second grommet 75. Grommets 55 and 75 serve as a means not only of coupling first strap 42 or 62 to second strap 46 or 66, respectively. Grommets 55 and 75 also provide a strong and reliable means of affixing affixment ends 44 and 48 or 64 and 68 to motorcycle seat 30 (discussed hereinafter). Desirably, grommets 55 and 75 are common #0 brass grommets, though it will be appreciated that this is not a requirement of the present invention.

In the alternative embodiment of FIG. 3, for each of first and second securement devices 40 and 60, first and second straps 42 and 46 or 62 and 66 are completely separate. That is, they are formed of separate pieces of strapping material. This alternative embodiment may be used whenever it is desired that first and second straps 42 and 46 or 62 and 66 be separate, as for replacement purposes.

In the alternative embodiment of FIG. 3, the separate affixment ends 44, 48, 64, and 68 may have separate grommets 56, 57, 76, and 77, as depicted in FIG. 3, or may have a single grommet 55 or 75 per pair of affixment ends 44 and 46 or 64 and 68, as depicted in FIG. 2. Those skilled in the art will appreciate that the use of separate grommets, pairing grommets, or affixment means other than grommets does not depart from the spirit of the present invention.

Any reference hereinafter to any component in FIG. 2 is assumed to apply equally to the like component in the embodiment of FIG. 3. Those skilled in the art will appreciate that the use of the alternative embodiment of FIG. 3 neither alters the definitions or existence of first and second securement devices 40 and 60 or any components thereof, nor departs from the spirit of the present invention.

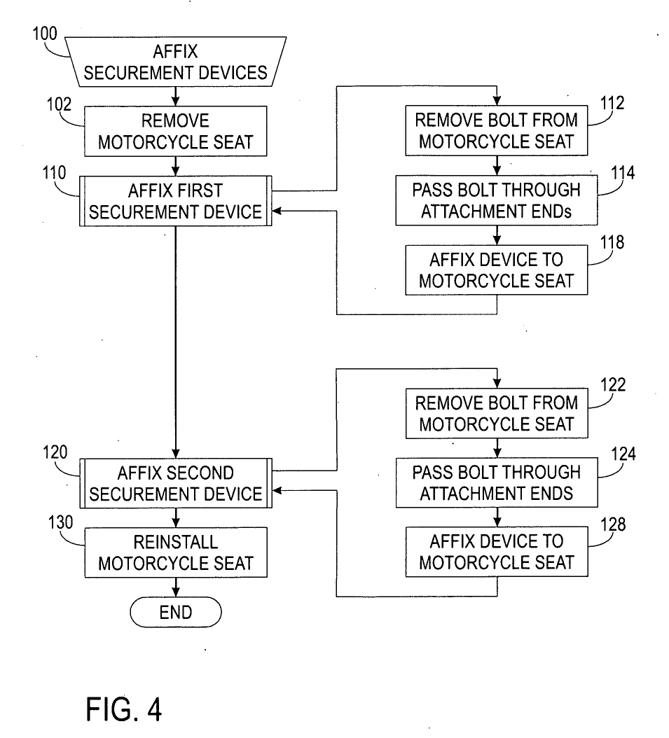

FIG. 4 depicts a block diagram of a process 100 to affix first and second securement devices 40 and 60 to motorcycle seat 30, and FIG. 5 depicts an exploded oblique view thereof in accordance with a preferred embodiment of the present invention. The following discussion refers to FIGS. 2, 4 and 5.

In process 100, first and second securement devices 40 and 60 are affixed to motorcycle seat 30. Affixment process 100 is made up of a seat removal task 102, a first-device affixment subprocess 110, a second-device affixment subprocess 120, and a seat reinstallation task 130.

In seat removal task 102, motorcycle seat 30 is removed from motorcycle 22. This is effected in a manner appropriate for the particular motorcycle 22, which manner is well-known to those skilled in the art.

In first-device affixment subprocess 110, first securement device 40 is affixed to motorcycle seat 30.

In a task 112 of subprocess 110, a first seat bolt 32 is removed from an underside 36 of motorcycle seat 30.

In a task 114 of subprocess 110, first seat bolt 32 is passed through first grommet 55, i.e., through second affixment end 48 and first affixment end 44 of second strap 46 of first securement device 40.

In a task 118 of subprocess 110, first seat bolt 32 is rebolted to underside 36 of seat 30, thereby affixing first securement device 40 to motorcycle seat 30.

In second-device affixment subprocess 120, second securement device 60 is affixed to motorcycle seat 30.

In a task 122 of subprocess 120, a second seat bolt 34 is removed from underside 36 of motorcycle seat 30.

In a task 124 of subprocess 120, second seat bolt 34 is passed through second grommet 75, i.e., through second affixment end 68 and first affixment end 64 of second strap 66 of second securement device 60.

In a task 128 of subprocess 120, second seat bolt 34 is rebolted to underside 36 of seat 30, thereby affixing second securement device 60 to motorcycle seat 30.

In task 130, motorcycle seat 30 is reinstalled upon motorcycle 22 in a manner appropriate for motorcycle 22 and known to those skilled in the art.

Those skilled in the art will appreciate that the order in which subprocesses 110 and 120 of process 100 are effected is not germane to the present invention.

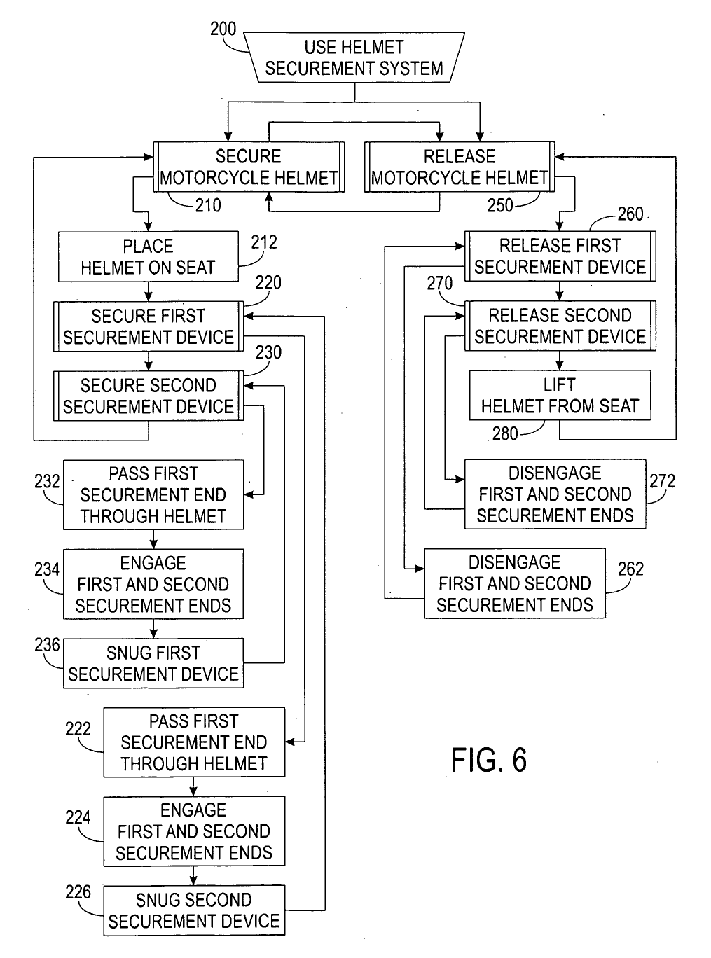

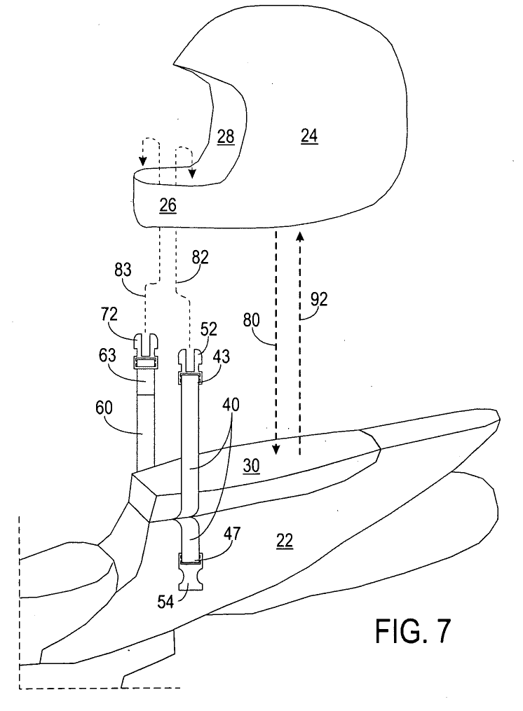

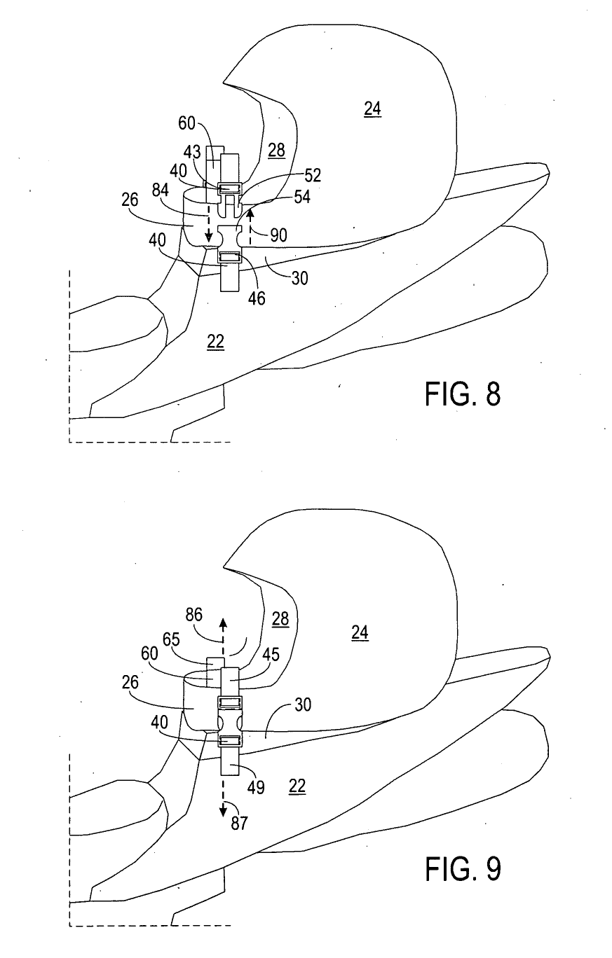

FIG. 6 depicts a block diagram of a process 200 to use motorcycle helmet securement system 20 in accordance with a preferred embodiment of the present invention. In conjunction with a subprocess 210 of process 200, FIGS. 7, 8, and 9 depict exploded oblique views of the placement of motorcycle helmet 24 upon motorcycle seat 30 (FIG. 7), the engagement of securement ends 43, 47 and 63, 67 of securement devices 40 and 60 (FIG. 8), and the securement of motorcycle helmet 24 upon motorcycle seat 30 (FIG. 9) in accordance with a preferred embodiment of the present invention. The following discussion in conjunction with subprocess 210 refers to FIGS. 2, 6, 7, 8, and 9.

Once affixment process 100 (discussed hereinbefore in conjunction with FIGS. 2, 4, and 5)) has been completed, first and second securement devices 40 and 60 should extend from the junction of motorcycle seat 30 and motorcycle 22 as depicted in FIG. 7.

Through process 200, motorcycle helmet securement system 20 may be used. Usage process 200 is made up of subprocess 210 to secure motorcycle helmet 24 to motorcycle seat 30, and a subprocess 250 to release motorcycle helmet 24 from motorcycle seat 30. Subprocesses 210 and 250 are iteratively and alternately effected. Those skilled in the art will appreciate that there is no order in which subprocesses 210 and 250 are effected. Rather, whenever helmet 24 is not secured to seat 30, securement subprocess 210 may be used to secure helmet 24, and whenever helmet 24 is secured to seat 30, releasing subprocess 250 may be used to release helmet 24.

Securement subprocess 210 is made up of a placement task 212, a first-device securement hypertask 220, and a second-device securement hypertask 230.

In placement task 212 (FIGS. 6 and 7), motorcycle helmet 24 is placed upon motorcycle seat 30 in a placement direction 80.

In first-device securement hypertask 220, motorcycle helmet 24 is secured to motorcycle seat 30 by first securement device 40.

In a task 222 of hypertask 220 (FIGS. 6 and 7), first securement end 43 of first securement device 40, i.e., first buckle component 51 of first buckle 50, is passed through an inside 28 of helmet 24 and over chin guard 26 in a first passage direction 82.

In a task 224 of hypertask 220 (FIGS. 6, 7, and 8), first and second securement ends 43 and 47 of first securement device 40, i.e., first and second buckle components 51 and 52 of first buckle 50, are engaged in a manner appropriate for first buckle 50 and known to those skilled in the art. In the preferred embodiment of the Figures, task 224 is effected by inserting first buckle component 51 into second buckle component 52 in an engagement direction 84.

In a task 226 of hypertask 220 (FIGS. 6 and 9), first securement device 40 is snugged by pulling first tag end 45 of first securement device 40 in a first snugging direction 86 and/or pulling second tag end 49 of first securement device 40 in a second snugging direction 87. This secures motorcycle helmet 24 to motorcycle seat 30 by first securement device 40.

In second-device securement hypertask 230, motorcycle helmet 24 is further secured to motorcycle seat 30 by second securement device 60.

In a task 232 of hypertask 230 (FIGS. 6, and 7), first securement end 63 of second securement device 60, i.e., first buckle component 71 of second buckle 70, is passed through an inside 28 of helmet 24 and over chin guard 26 in a second passage direction 83.

In a task 234 of hypertask 230 (FIGS. 6, 7, and 8), first and second securement ends 63 and 67 (FIG. 2) of second securement device 60 (FIGS. 2 and 7), i.e., first and second buckle components 71 and 72 (FIG. 2) of second buckle 70 (FIG. 2), are engaged in a manner appropriate for buckle 70 and known to those skilled in the art. In the preferred embodiment of the Figures, task 234 is effected by inserting first buckle component 71 into second buckle component 72 in an engagement direction 84 (FIG. 8).

In a task 226 of hypertask 230 (FIGS. 6 and 9), second securement device 60 is snugged by pulling first tag end 65 of second securement device 60 in first snugging direction 86 and/or pulling second tag end 69 (FIG. 2) of second securement device 60 in second snugging direction 87. This further secures motorcycle helmet 24 to motorcycle seat 30 by second securement device 60.

After subprocess 210 has been effected, motorcycle helmet is effectively and safely secured to motorcycle seat 30 by both first and second securement devices 40 and 60.

Those skilled in the art will appreciate that the order in which hypertasks 220 and 230 of subprocess 210 are effected is not germane to the present invention.

In conjunction with subprocess 250 of process 200, FIGS. 8 and 7 (in that order) depict exploded oblique views of the disengagement of securement ends 43, 47 and 63, 67 of securement devices 40 and 60 (FIG. 8), and the release of motorcycle helmet 24 from motorcycle seat 30 (FIG. 7) in accordance with a preferred embodiment of the present invention. The following discussion in conjunction with subprocess 250 refers to FIGS. 2, 6, 7, and 8.

Release subprocess 250 is made up of a first-device releasing hypertask 260, a second-device releasing hypertask 270, and a helmet lifting task 280.

In a task 262 of hypertask 260 (FIGS. 6 and 9), first securement end 43, i.e., first buckle component 51, of first securement device 40 is disengaged from second securement end 47 of first securement device 40, i.e., second buckle component 52 of first buckle 50, in a manner appropriate for buckle 50 and known to those skilled in the art. In the preferred embodiment of the Figures, task 262 involves squeezing the latching tabs 53 (FIG. 2) of first buckle component 51, and moving first buckle component 51 away from second buckle component 52 in a disengagement direction 90.

In second-device releasing hypertask 270, motorcycle helmet 24 is further release from motorcycle seat 30.

In a task 272 of hypertask 270 (FIGS. 6 and 9), first securement end 63 (FIG. 2) of second securement device 60 (FIG. 2), i.e., first buckle component 71 (FIG. 2) of second buckle 70 (FIG. 2), is disengaged from second securement end 67 (FIG. 2) of second securement device 60 (FIG. 2), i.e., second buckle component 72 (FIG. 2) of second buckle 70 (FIG. 2), in a manner appropriate for buckle 70 and known to those skilled in the art. In the preferred embodiment of the Figures, task 272 involves squeezing the latching tabs 73 (FIG. 2) of first buckle component 71, and moving first buckle component 71 away from second buckle component 72 in disengagement direction 90.

Once hypertasks 260 and 270 have been effected, motorcycle helmet 24 is fully disengaged from motorcycle seat 30.

In lifting task 280 (FIGS. 6 and 7), motorcycle helmet 24 is lifted from motorcycle seat 30 in lifting direction 92.

Those skilled in the art will appreciate that the order in which hypertasks 260 and 270 of subprocess 250 are effected is not germane to the present invention.

While not demonstrated in the Figures, it will be appreciated that, when motorcycle helmet 24 is not secured to motorcycle seat 30, the securement ends 43, 47, 63, and 67 (FIGS. 2 and 7) of first and second securement devices 40 and 60 (FIG. 7) may be tucked under seat 30. This would keep securement ends 43, 47, 63, and 67 from posing a potential hazard to the operator, to motorcycle 22, or to themselves, and would improve the aesthetics of motorcycle 22.

Alternatively, securement ends 43, 47, 63, and 67 may be cross-coupled. That is, first securement end 43 of first securement device 40 may be engaged with second securement end 67 of second securement device 60, and first securement end 63 of second securement device 60 may be engaged with second securement end 47 of first securement device 40. Tag ends 45, 49, 65, and 69 may then be tucked under first and second securement devices 40 and 60.

In summary, the present invention teaches a motorcycle helmet securement system and methods of attachment and usage thereof. The straightforward and simple design of motorcycle helmet securement system 20 makes it easy and cost effective to manufacture, practical for use with virtually any make or model of motorcycle 22, easy and quick to use, safe, secure, and imposes no substantial burden when not in use.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A motorcycle helmet securement system comprising:
a motorcycle seat;
a securement device comprising:
a first strap of said securement device comprising:
a first securement end of said securement device; and
a first affixment end of said securement device, wherein said first affixment end is affixed to said motorcycle seat; and
a second strap of said securement device comprising:
a second securement end of said securement device; and
a second affixment end of said securement device, wherein said second affixment end is affixed to said motorcycle seat; and
a motorcycle helmet configured to be secured to said motorcycle seat by said securement device.

2. A motorcycle helmet securement system as claimed in claim 1 wherein:
said motorcycle seat comprises an underside; and
said first and second affixment ends of said securement device are affixed to said underside of said motorcycle seat.

3. A motorcycle helmet securement system as claimed in claim 2 wherein:
said motorcycle seat further comprises a seat bolt; and
said first and second affixment ends of said securement device are affixed to said underside of said motorcycle seat by said seat bolt.

4. A motorcycle helmet securement system as claimed in claim 1 wherein said securement device additionally comprises:
a buckle comprising:
a first buckle component attached to said first securement end of said securement device; and
a second buckle component attached to said second securement end of said securement device and configured to engage to said first buckle component.

5. A motorcycle helmet securement system as claimed in claim 1 wherein:
said motorcycle helmet further comprises a chin guard; and
said first securement end of said securement device is configured to pass through an inside of said motorcycle helmet, configured to pass over said chin guard, and configured to engage said second securement end of said securement device.

6. A motorcycle helmet securement system as claimed in claim 1 wherein:
said securement device is a first securement device;
said motorcycle helmet securement system additionally comprises:
a second securement device comprising:
a first strap of said second securement device comprising:
a first securement end; and
a first affixment end, wherein said first affixment end of said second securement device is affixed to said motorcycle seat; and
a second strap of said second securement device comprising:
a second securement end; and
a second affixment end, wherein said second affixment end of said second securement device is affixed to said motorcycle seat; and
said motorcycle helmet is configured to be secured to said motorcycle seat by said first and second securement devices.

7. A motorcycle helmet securement system as claimed in claim 6 wherein:
said motorcycle seat comprises an underside;
said first and second affixment ends of said first securement device are affixed to said to said underside of said motorcycle seat; and
said first and second affixment ends of said second securement device are affixed to said underside of said motorcycle seat.

8. A motorcycle helmet securement system as claimed in claim 7 wherein:
said motorcycle seat further comprises:
a first seat bolt; and
a second seat bolt;
said first and second affixment ends of said first securement device are affixed to said underside of said motorcycle seat by said first seat bolt; and
said first and second affixment ends of said second securement device are affixed to said underside of said motorcycle seat by said second seat bolt.

9. A motorcycle helmet securement system as claimed in claim 6 wherein:
said first securement device additionally comprises a first buckle comprising:
a first buckle component attached to said first securement end of said first securement device; and
a second buckle component attached to said second securement end of said first securement device and configured to engage said first buckle component of said first buckle; and
said second securement device additionally comprises a second buckle comprising:
a first buckle component attached to said first securement end of said second securement device; and
a second buckle component attached to said second securement end of said second securement device and configured to engage said first buckle component of said second buckle.

10. A motorcycle helmet securement system as claimed in claim 6 wherein:
said motorcycle helmet further comprises a chin guard;
said first securement end of said first securement device is configured to pass through an inside of said motorcycle helmet, configured to pass over said chin guard, and configured to engage said second securement end of said first securement device; and
said first securement end of said second securement device is configured to pass through said inside of said motorcycle helmet, configured to pass over said chin guard, and configured to engage said second securement end of said second securement device.

11. A motorcycle helmet securement system as claimed in claim 1 wherein said first strap of said securement device is conjoined with said second strap of said securement device, said first affixment end of said securement device being proximate said second affixment end of said securement device.

12. A usage method for a motorcycle helmet securement system, said usage method comprising securing a motorcycle helmet to a motorcycle, said securing activity comprising:
placing said motorcycle helmet upon a motorcycle seat of said motorcycle;
passing a first securement end of a securement device of said motorcycle helmet securement system through an inside of said motorcycle helmet; and
engaging said first securement end of said securement device with a second securement end of said securement device.

13. A usage method as claimed in claim 12 wherein said engaging activity engages a first buckle component of a buckle with a second buckle component of said buckle, wherein said first buckle component of said buckle is attached to said first securement end of said securement device, and said second buckle component of said buckle is attached to said second securement end of said securement device.

14. A usage method as claimed in claim 12 additionally comprising releasing said motorcycle helmet from said motorcycle, said releasing activity comprising:
releasing said securement device, said releasing activity comprising disengaging said first securement end of said securement device from said second securement end of said securement device; and
lifting said motorcycle helmet from said motorcycle seat.

15. A usage method as claimed in claim 12 wherein said securement device is a first securement device, and said securing activity additionally comprises:
passing a first securement end of a second securement device of said motorcycle helmet securement system through said inside of said motorcycle helmet; and
engaging said first securement end of said second securement device with a second securement end of said second securement device.

16. A usage method as claimed in claim 15 wherein:
said engaging activity for said first securement device engages a first buckle component of a first buckle with a second buckle component of said first buckle, wherein said first buckle component of said first buckle is attached to said first securement end of said first securement device, and said second buckle component of said first buckle is attached to said second securement end of said first securement device; and
said engaging activity for said second securement device engages a first buckle component of a second buckle with a second buckle component of said second buckle, wherein said first buckle component is affixed to said first securement end of said second securement device, and said second buckle component of said second buckle is affixed to said second securement end of said second securement device.

17. A usage method as claimed in claim 15 additionally comprising releasing said motorcycle helmet from said motorcycle, said releasing activity comprising:
releasing said first securement device, said releasing activity comprising disengaging said first securement end of said first securement device from said second securement end of said first securement device;
releasing said second securement device, said releasing activity comprising disengaging said first securement end of said second securement device from said second securement end of said second securement device; and
lifting said motorcycle helmet from said motorcycle seat.

18. An affixment method for a motorcycle helmet securement system, said affixment method comprising:
removing a motorcycle seat from a motorcycle;
affixing a securement device to said motorcycle seat, wherein said securement device has:
a first affixment end of said securement device; and
a second affixment end of said securement device; and
reinstalling said motorcycle seat upon said motorcycle.

19. An affixment method as claimed in claim 18 wherein said attaching activity comprises:
removing a seat bolt from an underside of said motorcycle seat;
passing said seat bolt through said second affixment end and said first affixment end of said securement device; and
affixing said securement device to said underside of said motorcycle seat.

20. An affixment method as claimed in claim 18 wherein:
said securement device is a first securement device;
said affixment method additionally comprises attaching a second securement device to said motorcycle seat, wherein said second securement device has:
a first affixment end; and
a second affixment end;
said attaching activity for said first securement device comprises:
removing a first seat bolt from an underside of said motorcycle seat;
passing said first seat bolt through said second affixment end and said first affixment end of said first securement device; and
affixing said first securement device to said underside of said motorcycle seat; and
said attaching activity for said second securement device comprises:
removing a second seat bolt from said underside of said motorcycle seat;
passing said second seat bolt through said second affixment end and said first affixment end of said second securement device; and
affixing said second securement device to said underside of said motorcycle seat.
